(19) United States
(12) Patent Application Publication
(10) Pub. No.: US 2009/0214825 A1
(43) Pub. Date: Aug. 27, 2009

(54) Ceramic coating comprising yttrium which is resistant to a reducing plasma

(75) Inventors: Jennifer Y. Sun, Sunnyvale, CA (US); Xiaoming He, Arcadia, CA (US); Kenneth S. Collins, San Jose, CA (US); Thomas Graves, Los Altos, CA (US); Senh Thach, Union City, CA (US); Jie Yuan, San Jose, CA (US); Li Xu, San Jose, CA (US); Ren-Guan Duan, Fremont, CA (US)

Correspondence Address: SHIRLEY L. CHURCH, ESQ., P.O. BOX 81146, SAN DIEGO, CA, 92138, US

(73) Assignee: Applied Materials, Inc.

(21) Appl. No.: 12/072,530

(22) Filed: Feb. 26, 2008

(51) Int. Cl. B32B 7/00; C23C 4/00

(52) U.S. Cl. 428/141; 427/453; 428/312.8

(57) ABSTRACT

Particulate generation has been a problem in semiconductor device processing in highly corrosive plasma environments. The problem is exacerbated when the plasma is a reducing plasma. Empirically produced data has shown that the formation of a plasma spray coated yttrium-comprising ceramic such as yttrium oxide, Y₂O₃—ZrO₂ solid solution, YAG, and YF₃ provides a low porosity coating with smooth and compacted surfaces when such ceramics are spray coated from a powder feed having an average effective diameter ranging from about 22 μm to about 0.1 μm. These spray-coated materials reduce the generation of particulates in corrosive reducing plasma environments.

The present application is related to two other applications pertaining to semiconductor processing components which make use of a spray-coated, yttrium-comprising ceramic material. The spray-coated, yttrium-comprising ceramic material is frequently applied over an aluminum or aluminum alloy substrate. The related applications are U.S. application Ser. No. 10/075,967 of Sun et al., filed Feb. 14, 2002, titled: “Yttrium Oxide Based Surface Coating For Semiconductor IC Processing Vacuum Chambers”, which issued as U.S. Pat. No. 6,776,873 on Aug. 17, 2004; and, application Ser. No. 10/898,113 of Sun et al., filed Jul. 22, 2004, titled: “Clean Dense Yttrium Oxide Coating Protecting Semiconductor Apparatus”, which was published as US 2005/0037193 A1 on Feb. 17, 2005, and which is currently pending. The subject matter of the referenced patent and application is hereby incorporated by reference into the present description.

### BACKGROUND

1. Field

Embodiments of the present invention relate to a plasma or flame sprayed yttrium-comprising coating useful as a protective coating over processing surfaces in a semiconductor processing environment. The plasma or flame sprayed yttrium-comprising coating is particularly useful in a reducing plasma to prevent particulate contamination of a substrate which is being processed.

2. Background

This section describes background subject matter related to the disclosed embodiments of the present invention. There is no intention, either express or implied, that the background art discussed in this section legally constitutes prior art.

Corrosion (including erosion) resistance is a critical property for apparatus components and liners used in semiconductor processing chambers, where corrosive environments are present. Although corrosive plasmas are present in the majority of semiconductor processing environments, including plasma enhanced chemical vapor deposition (PECVD) and physical vapor deposition (PVD), the most corrosive plasma environments are those used for cleaning of processing apparatus and those used to etch semiconductor substrates. This is especially true where high-energy plasma is present and combined with chemical reactivity to act upon the surface of components present in the environment. When the high-energy plasma is a reducing plasma, such as a hydrogen species-containing plasma, the formation of particulates in the processing chamber has been observed to be a problem. The particulates often contaminate the surfaces of devices contained in a substrate which is processed in the semiconductor processing chamber.

Process chamber liners and component apparatus present within the processing chambers used to fabricate electronic devices and micro-electro-mechanical systems (MEMS) are frequently constructed from aluminum and aluminum alloys. Surfaces of the process chamber and component apparatus (present within the chamber) are frequently anodized to provide a degree of protection from the corrosive environment. However, the integrity of the anodization layer may be deteriorated by impurities in the aluminum or aluminum alloy, so that corrosion begins to occur early, shortening the life span of the protective coating. The plasma resistance properties of aluminum oxide are not positive in comparison with some other ceramic materials. As a result, ceramic coatings of various compositions have been used in place of the aluminum oxide layer mentioned above; and, in some instances, have been used over the surface of an anodized layer present on an aluminum alloy substrate, to improve the protection of the underlying aluminum-based materials.

Yttrium oxide is a ceramic material which has shown considerable promise in the protection of aluminum and aluminum alloy surfaces which are exposed to halogen-containing plasmas of the kind used in the fabrication of semiconductor devices. A spray-coated yttrium oxide coating has been applied over an anodized surface of a high purity aluminum alloy process chamber surface, or a process component surface, to produce excellent corrosion protection (e.g. U.S. Pat. No. 6,777,873 to Sun et al., mentioned above).

The substrate base material of the chamber wall or liner, of an apparatus component may be a ceramic material (Al₂O₃, SiO₂, AlN, etc.), may be aluminum, or stainless steel, or may be another metal or metal alloy. Any of these may have a sprayed film over the base material. The film may be made of a compound of a III-B element of the periodic table, such as Y₂O₃. The film may substantially comprise Al₂O₃ and Y₂O₃. A sprayed film of yttrium-aluminum-garnet (YAG) has also been mentioned. Examples of a sprayed film thickness range from 50 μm to 300 μm, for example.

There have been problems with aluminum and aluminum alloys which have been spray coated with a yttrium oxide-comprising film to provide corrosion and erosion resistance. In particular, as part of the rigorous challenges in integrated circuit (IC) etch for the 45 nm and 32 nm technology nodes (as well as future technology nodes), particulates and contaminants produced during the IC fabrication operations have reduced the yield of acceptable devices.

There is a need in the semiconductor industry to reduce the amount of particulates and contamination generated during plasma processing as part of the manufacture of IC components, particularly when the plasma is a reducing plasma.

### DESCRIPTION

It had been observed that particulates were becoming a problem during semiconductor device processing in highly corrosive plasma environments. The particulates affected semiconductor device yields. Empirically generated data has shown that the ceramic protective coatings used to protect semiconductor processing chamber surfaces and apparatus components present within the chamber were the source of a large amount of the particulates. Empirically generated data has shown that by polishing the surface of a ceramic-coated process chamber liner or an apparatus component, prior to use of the ceramic-coated apparatus, the amount of particulate generation could be reduced. Still, the amount of particulates generated affected semiconductor yields significantly.

The problem of particulate generation was particularly bad when the environment in a plasma processing chamber was a reducing atmosphere. A number of plasma processes make use of hydrogen among other reactive species, and this reducing environment produces increased particulates over those observed when hydrogen is not present. An extensive development project was carried out which resulted in embodiments of the present invention which pertain to forming an improved protective ceramic coating which produces fewer particulates in a reducing environment. The development program was based on yttrium-comprising ceramics. These yttrium-comprising ceramics included yttrium oxide (Y₂O₃), Y₂O₃—ZrO₂ solid solution, YAG, and YF₃ in addition to more exotic ceramic coating compositions designed to provide particular mechanical, physical or electrical properties.

Photomicrographs of specimens cut from aluminum substrates coated with a yttrium oxide coating, which was applied using known in the art plasma spray coating techniques, showed a substantial increase in porosity and surface roughness after exposure to a plasma containing reducing species. It was empirically determined that a substantial reduction in porosity and surface roughness of the spray-coated yttrium oxide surface could be obtained by using a smaller average particle size yttrium oxide powder feed to the plasma spray coating apparatus used to apply the coating. Embodiments of the present invention employ smaller (than conventionally used) average particle size Y₂O₃, Y₂O₃—ZrO₂ solid solution, YAG, and YF₃ powder to spray coat a substrate. For example, the conventional effective particle diameter of yttrium oxide powder fed to the plasma spray-coating apparatus prior to the present invention was about 25 μm or larger. An unexpected improvement in corrosion/erosion resistance to reducing plasmas was obtained when the effective particle diameter fed to a plasma spray-coating apparatus was reduced to less than about 22 μm, and typically less than about 15 μm, with the effective particle diameter frequently ranging between about 15 μm and about 5 μm. Smaller effective particle diameter powders, down to 0.1 μm, may be used in instances when the spray-coating system can be adapted to handle such particles. Substrates spray-coated using the reduced particle size powders show a corresponding substantial and unexpected reduction in the average porosity of the yttrium-comprising spray coating. This reduction in average porosity has been observed in coating embodiments for Y₂O₃, Y₂O₃—ZrO₂ solid solution, YAG, and YF₃ deposited over an aluminum alloy substrate surface. For example, for a 200 μm thick coating, the average porosity of the yttrium oxide coating produced using the previous spray coating technique, which employed an effective powder diameter for the yttrium oxide of 25 μm or larger, ranges from above 1.5% to about 4%, measured using Image-Pro Plus™ Version 6.0 software in combination with an SEM microstructure image. This compares with an average porosity ranging from less than 1.5% down to about 0.15% for a yttrium oxide coating produced using a plasma spray coating embodiment of the present invention in which the average effective powder diameter fed to the plasma spray apparatus ranged from about 22 μm down to about 5 μm. By way of example, a yttrium oxide coating having an average porosity of about 0.47% was achieved using a 15 μm effective powder diameter. In addition, the average surface roughness of the yttrium oxide coating produced using the 25 μm effective diameter powder was about 200μ-inch Ra (5.0 μm Ra) compared with an average surface roughness of only 51.2μ-inch Ra (1.28 μm Ra) for the yttrium oxide coating produced using the 15 μm diameter powder yttrium oxide feed to the laser spray coating apparatus. In embodiments of the invention in general, the average surface roughness may range from about 3 μm Ra to about 0.6 μm Ra.

With respect to the 200 μm thick yttrium oxide coating described above, using a standard HCl bubble test which is described subsequently herein, the yttrium oxide coating produced using the 25 μm effective diameter yttrium oxide powder performed well for about 7.5-8 hours, while the yttrium oxide coating produced using the 15 μm (or smaller) diameter powder performed well for a time period in excess of 10 hours. Further, the break down voltage (V_{BD}) for the yttrium oxide coating produced using the 25 μm diameter powder was 750 V/mil, while the break down voltage for the yttrium oxide coating produced using the 15 μm diameter powder was at least 875 V/mil.

One of skill in the art can select any of the plasma spray-coating apparatus commonly used in the industry for spray coating of yttrium-comprising coatings and obtain similar relative results, with minimal experimentation.

The use of a smaller effective diameter yttrium-comprising powder provides a less efficient coating of the substrate, with more powder consumed per thickness of coating deposited. Since the yttrium-containing powders are expensive, no effort was made to develop the use of smaller diameter yttrium-comprising powders for spray coating. The unexpected relative advantages in performance properties of the coatings produced when effective powder diameters ranging from about 22 μm down to about 0.1 μm, according to embodiments of the present invention, are used more than justifies the use of the smaller effective powder diameters. For example, the sprayed coatings having a thickness of 300 μm or less exhibit porosities ranging from about 0.15% to less than about 1.5%, measured using the Image-Pro Plus™ software in the manner previously described. Empirically generated data showed that a spray-coated yttrium oxide processing component produced using the improved spray coating technique employing the smaller effective diameter powders, according to embodiments of the present invention, was even more resistant to erosion in a reducing plasma and produced fewer particulates than a solid yttrium oxide component. This was presumed to be due to the fact that the solid yttrium oxide component required the use of a sintering additive, which produced an intergranular glassy phase, where the intergranular glassy phase is a source of particulate formation.

While working to improve the performance of the yttrium oxide coating in a reduced plasma, we discovered that the mechanism of attack of the yttrium oxide surface is through the formation of yttrium hydroxide, Y(OH)₃. When reactive plasma species of hydrogen or hydrogen and oxygen are present, the Y(OH)₃ compound is formed. When reactive plasma species of hydrogen, fluorine, and oxygen are present, the Y(OH)₃ compound is formed, and YF₃ compound is formed as well, with the YF₃ formation being preferentially formed based on thermodynamic considerations.

The Y(OH)₃ formed in a reducing atmosphere on a yttrium oxide surface is the main reason particulates are generated. Once this discovery was made, further experimentation showed that there are several exemplary methods, in accordance with embodiments of the invention, which can be used to reduce the quantity of particulates formed: 1) Continue to use a yttrium oxide coating, but produce a denser, smoother Y₂O₃ plasma sprayed coating which is attacked at a slower rate by the reducing species. This is achieved by reducing the effective particle size diameter powder for the spray-coating formation to range from about 22 μm to about 0.1 μm. 2) Substitute a YAG (Yttrium Aluminum Garnet, which is commonly used in a Y₃Al₅O₁₂ form), or a Y₂O₃—ZrO₂ solid solution, or a YF₃ composition (or a combination thereof) to the plasma spray-coating apparatus to form a YAG, or Y₂O₃—ZrO₂ solid solution, or YF₃ (or a combination thereof) coating. These materials reduce or avoid, respectively the formation of Y(OH)₃. And, 3) Substitute a YAG, or a Y₂O₃—ZrO₂ solid solution, or a YF₃ (or a combination thereof) material for the Y₂O₃ and reduce the size of the YAG, or Y₂O₃—ZrO₂ solid solution, or YF₃ (or combinations thereof) effective diameter powder to the plasma spray-coating apparatus to range between about 22 μm to 0.1 μm. More practically, a powder diameter ranging from about 15 μm to about 5 μm is used. Coating thicknesses ranging from 5 μm to 400 μm have been produced. More commonly, a coating thickness ranging from about 25 μm to about 300 μm is used.

### BRIEF DESCRIPTION OF THE DRAWINGS

So that the manner in which the exemplary embodiments of the present invention are attained is clear and can be understood in detail, with reference to the particular description provided above, and with reference to the detailed description of exemplary embodiments, applicants have provided illustrating drawings. It is to be appreciated that drawings are provided only when necessary to understand the invention and that certain well known processes and apparatus are not illustrated herein in order not to obscure the inventive nature of the subject matter of the disclosure.

FIG. 1 is a cross-sectional schematic 100 of one type of plasma spraying system of the kind known in the art which may be used to apply coatings of the present invention.

FIGS. 2A, 2B, and 2C show comparative photomicrographs 200, 210, and 220 of the surface of a previously known as-coated plasma sprayed yttrium oxide coating at magnifications of 300×, 1000×, and 5000×, respectively.

FIGS. 2D, 2E, and 2F show photomicrographs 230, 240, and 250 of the surface of the as-coated plasma sprayed yttrium oxide coating illustrated in FIGS. 2A through 2C after exposure to a reducing chemistry plasma. FIG. 2D is at a magnification of 300×, FIG. 2E is at a magnification of 1000×, and FIG. 2F is at a magnification of 5000×.

FIGS. 3A, 3B, and 3C show photomicrographs 300, 310, and 320 of the surface of a lapped (polished) as-coated plasma sprayed yttrium oxide coating at magnifications of 300×, 1000×, and 5000× respectively.

FIGS. 3D, 3E, and 3F show photomicrographs 330, 340, and 350 of the surface of the lapped (polished) sprayed yttrium oxide coating illustrated in FIGS. 3A through 3C after exposure to a reducing chemistry plasma. FIG. 3D is at a magnification of 300×, FIG. 3E is at a magnification of 1000×, and FIG. 3F is at a magnification of 5000×.

FIG. 4A is a comparative example which shows a graph 400 of the range of the surface roughness in microns from a centerline 410 along the surface of an as-coated plasma sprayed yttrium oxide coating produced using the technology available prior to the present invention.

FIG. 4B shows a graph 420 of the range of the surface roughness in microns from a centerline 430 along the surface of an as-coated plasma sprayed yttrium oxide coating produced using the technology of embodiments of the present invention.

FIGS. 5A and 5B are comparative photomicrographs 510 and 520, which show a top view of the morphology of a plasma sprayed yttrium oxide coating prepared using plasma spray technology prior to the present invention, at magnifications of 200× and 1000×, respectively.

FIGS. 5C and 5D are photomicrographs 530 and 540, which show a top view of the morphology of plasma sprayed yttrium oxide coating prepared using the plasma spray technology of an embodiment of the present invention, at magnifications of 200× and 1000×, respectively.

FIG. 6A is a photomicrograph 600 showing a cross-sectional side view of an aluminum alloy substrate 602 having a yttrium oxide coating 606 deposited over the surface 604 of the aluminum alloy substrate 602. This is a comparative photomicrograph which shows the characteristics of this structure which was prepared using plasma spray technology prior to the present invention, at a magnification of 200×.

FIG. 6B is a photomicrograph 610 showing a cross-sectional side view of an aluminum alloy substrate 612 having a yttrium oxide coating 616 deposited over the surface 614 of the aluminum alloy substrate 612. This photomicrograph shows the characteristics of this structure which was prepared using plasma spray technology which is an embodiment of the present invention, at a magnification of 200×.

FIG. 7A shows a block diagram 700 which compares an erosion rate for a plasma sprayed yttrium oxide coating (over an aluminum alloy substrate) applied using the prior art spray coating technology 704, with the erosion rate for a bulk substrate of yttrium oxide 706, with the erosion rate for a plasma sprayed yttrium oxide coating (over an aluminum substrate) applied using an embodiment of the present invention 708, where each of these test specimen substrates was exposed to the same plasma containing reducing species.

FIG. 7B shows a block diagram 720 which compares an erosion rate for a series bulk, sintered materials. Each of these test specimen substrates was exposed to the same plasma containing reducing species.

FIG. 8 shows a Table 800, listing the compositions of the various bulk materials for which the erosion rates are presented in FIG. 7B.

FIG. 9 shows a phase diagram 900 showing the majority of the materials which are listed in Table 800.

### DETAILED DESCRIPTION OF EXEMPLARY EMBODIMENTS

As a preface to the detailed description, it should be noted that, as used in this specification and the appended claims, the singular forms “a”, “an”, and “the” include plural referents, unless the context clearly dictates otherwise.

When the word “about” is used herein, this is intended to mean that the nominal value presented is precise within ±10%.

To facilitate understanding, identical reference numerals have been used, where possible, to designate identical elements that are common to the figures. It is contemplated that elements and features of one embodiment may be beneficially incorporated in other embodiments without further recitation. It is to be noted that the appended drawings illustrate only exemplary embodiments of the invention where a drawing would be particularly helpful in understanding the embodiment. Not all embodiments require a drawing for understanding, and therefore the drawings are not to be considered as limiting of the scope of the invention, for the invention may admit to other equally effective embodiments.

As discussed above, it had been observed that particulates were becoming a problem during semiconductor device processing in highly corrosive plasma environments. Empirically generated data showed that the ceramic protective coatings used to protect various semiconductor apparatus processing surfaces within the chamber were the source of a large amount of the particulates. In addition, when erosion rates were compared for various semiconductor processing plasmas, it became apparent that when the plasma was a reducing plasma, one which contained reducing species, particularly hydrogen, the production of particulates was increased.

The yield of devices per fabrication processes was decreasing as the device sizes became smaller and the presence of particulates on the semiconductor substrate surface became more significant with respect to device function. A program was initiated to reduce the production of particulates by the coatings used to protect the semiconductor processing apparatus surfaces.

The development program was based on yttrium-comprising ceramics. These yttrium-comprising ceramics included yttrium oxide, Y₂O₃—ZrO₂ solid solution, YAG, and YF₃ in addition to other more exotic yttrium-comprising ceramic materials which were designed to provide particular mechanical of electrical properties.

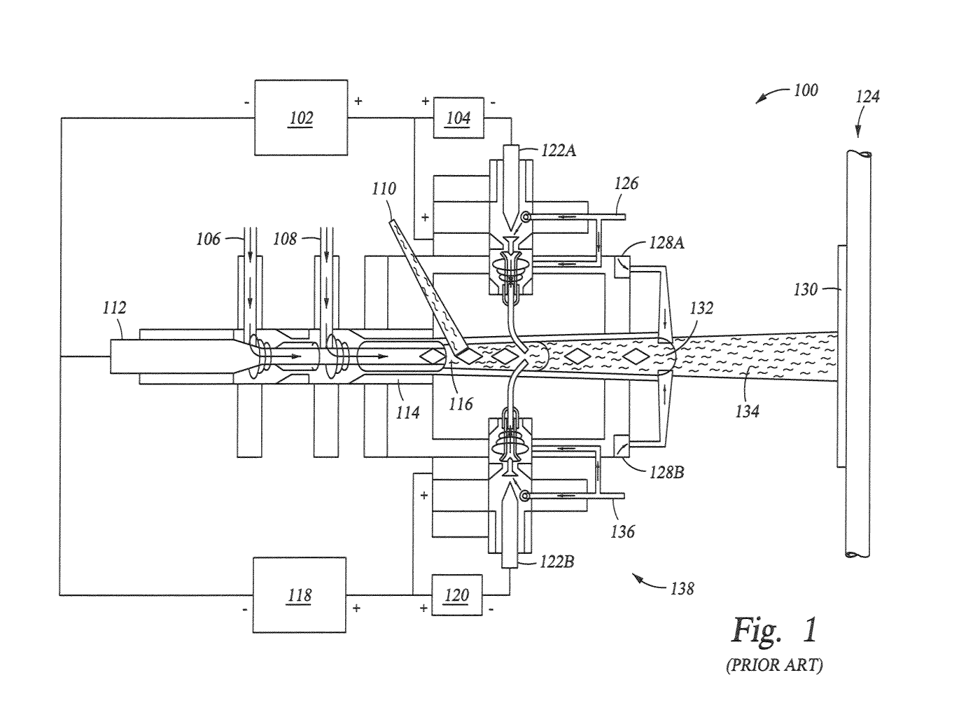

FIG. 1 shows a cross-sectional schematic 100 of a type of plasma spraying system which is useful in applying the coatings of the present invention. The particular apparatus illustrated in FIG. 1 is an APS 7000 Series Aeroplasma Spraying System available from Aeroplasma K.K. (Tokyo, Japan). The apparatus 100 includes the following components: first DC main electrode 102; first auxiliary electrode 104; first argon source 106; first air source 108; spray material powder source 110; cathode torch 112; accelerator nozzle 114; plasma arc 116; second DC main electrode 118; second auxiliary electrode 120; anode torch 122; spray base material source 124; second argon source 126; second air source (plasma trimming) 128 (128A and 128B); spray film 130; plasma jet 132; molten powder source 134; third argon source 136; and twin anode a torch 138.

Twin anode α torch 138 consists of two anode torches, so that each of the anode torches bears half of the thermal load. Using twin anode torch α 138, a high voltage can be obtained with relatively low current, so that the thermal load on each of the torches will be low. Each nozzle and electrode rod of the torches is water-cooled separately, and the arc starting point and ending point are protected by inert gas, so that stable operation at 200 hours or more is ensured, the service life of consumed parts is extended, and maintenance costs are reduced.

A stable high temperature arc is formed between the cathode torch 112 and the anode torch 122, and spray material can be fed directly into the arc. The spray material is completely melted by the high temperature arc column. The arc starting and ending points are protected by inert gas, so that air or oxygen can be used for the plasma gas introduced through the accelerator nozzle 114.

A plasma trimming function 128 is used for twin anode α. Plasma trimming trims the heat of the plasma jet that does not contribute to melting of the spray material, and reduces the thermal load on the substrate material and film to make spraying at short distances possible.

While one kind of plasma spray coating apparatus is shown in FIG. 1, one skilled in the art will recognize that other kinds of coating apparatus can be used to carry out the present invention as well. With the understanding of the information presented subsequently herein, one of skill in the art of plasma spray coating and flame spray coating can, with minimal experimentation, carry out the invention using varying coating deposition equipment.

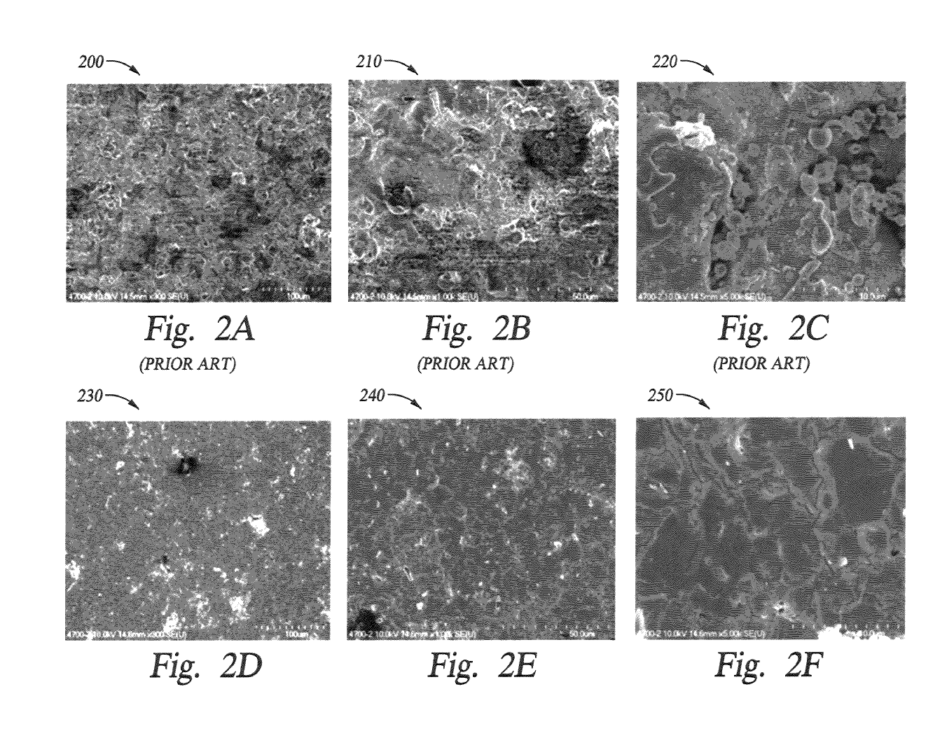

FIGS. 2A, 2B, and 2C show comparative photomicrographs 200, 210, and 220 of the upper surface of an as-coated plasma sprayed yttrium oxide coating having a thickness of about 200 μm, which was deposited using the technology prior to the present invention. The photomicrographs are at magnifications of 300×, 1000×, and 5000×, respectively. The flaky surface texture, which would enable direct particulate formation is readily apparent at all of the magnifications, but particularly at the 5000× magnification.

FIGS. 2D, 2E, and 2F show photomicrographs 230, 240, and 250 of the surface of the as-coated plasma sprayed yttrium oxide coating illustrated in FIGS. 2A through 2C after exposure to a reducing chemistry plasma. FIG. 2D is at a magnification of 300×, FIG. 2E is at a magnification of 1000×, and FIG. 2F is at a magnification of 5000×. The reducing plasma recipe was and is as shown in Table One, for the data in FIGS. 2, 3, and FIG. 7B, in a 300 mm eMax™ CT+ chamber of the kind available from Applied Materials, Inc., Santa Clara, Calif. The test specimen substrate evaluated was located on the wafer and then put at the ESC location within the processing chamber. It is clear that a large amount of the flaky topography which was illustrated in FIGS. 2A, 2B, and 2C has been removed during exposure to the reducing plasma. It is likely that the material which was removed is accountable for particulates which appear on the surface of a device-containing semiconductor structure processed using the reducing chemistry plasma.

TABLE ONE

| | | | | | | | | | | | | | B |
|---|---|---|---|---|---|---|---|---|---|---|---|---|---|
| | Ar | H₂ | CH₂F₂ | O₂ | CF₄ | CHF₃ | CO | N₂ | Press | RF H | RF L | RF S | fld |
| Step | SCCM | SCCM | SCCM | SCCM | SCCM | SCCM | SCCM | SCCM | mTorr | W | W | W | G |
| STAB 1 | | | | 14 | 150 | 50 | | | 200 | | | | |
| B/S | | | | 14 | 150 | 50 | | | 200 | 300 | 300 | | |
| Pump | 800 | | | | | | | | FO* | | | | |
| CHMO | | 250 | | | | | | 200 | 30 | 750 | | 500 | |
| STAB 2 | | | | 26 | 100 | 100 | | | 50 | | | | |
| ME | | | | 26 | 100 | 100 | | | 50 | 700 | 300 | | |
| STAB 3 | | | 40 | 28 | | 50 | 200 | | 250 | | | | |
| OE | | | 40 | 28 | | 50 | 200 | | 250 | 1000 | | | |
| STAB 4 | | | | 2020 | | | | | 250 | | | | 50 |
| ICC HP | | | | 2020 | | | | | 250 | | | 2500 | 50 |
| ICC LP | | | | 2020 | | | | | 50 | | | 2500 | 50 |
| Pump | 1500 | | | | | | | | FO* | | | | |
| Purge | | | | | | | | | | | | | |

*Fully Open

The substrate temperature during exposure to the processing recipe shown above was about 25° C.

It is readily apparent that the flaky topography has been removed from the yttrium oxide coating surface during exposure to the plasma, as illustrated by comparing FIG. 2C with FIG. 2F. This, in combination with a chemical composition of the particulates found on processed semiconductor device surfaces confirmed that the bulk of particulates were generated from the yttrium oxide coating.

A study in which the spray-coated yttrium oxide layer was examined as the depth into the coating thickness was increased, showed that the overall crystalline structure of the yttrium oxide and the porosity of the yttrium oxide coating was relatively constant throughout the thickness of the coating. However, as is illustrated by a comparison of the FIGS. 2A-2C with 2D-2F, it would be possible to avoid an initial heavy particle generation period when a newly-coated apparatus is introduced into a process chamber by removing the flaky upper surface of the as coated apparatus prior to using the apparatus to produce semiconductor devices.

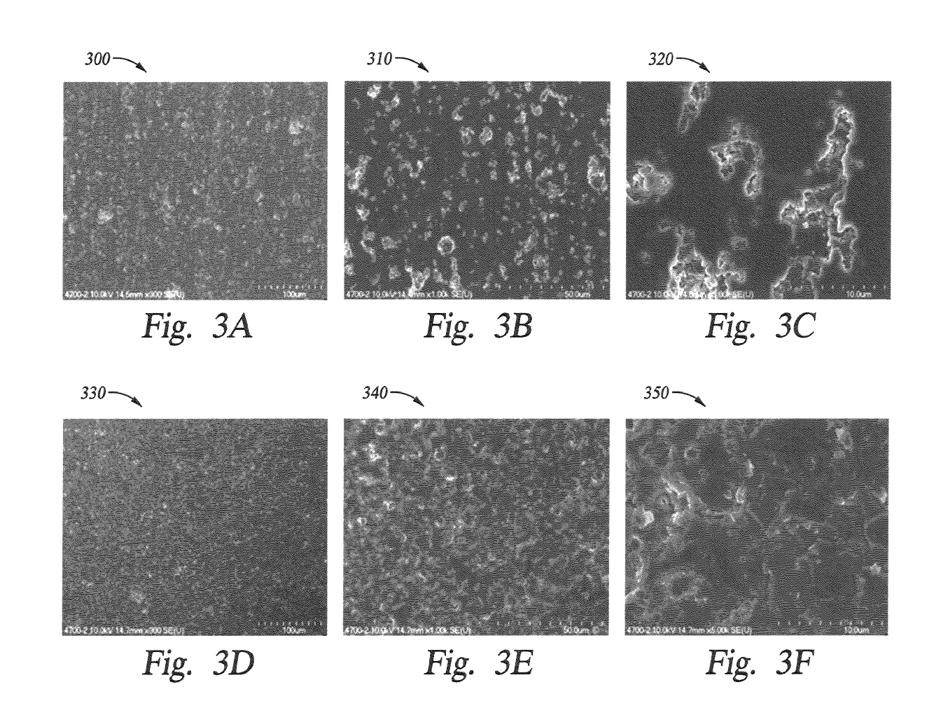

The flaky upper surface could be removed by exposure to the very reducing plasma which was described with respect to FIGS. 2D through 2F. However, this would require approximately 50 hours of exposure to the plasma, so this was not practical. Instead, the surface of the yttrium oxide plasma spray coated apparatus was polished using a lapping technique commonly known in the art for polishing ceramic materials. FIGS. 3A, 3B, and 3C show photomicrographs 300, 310, and 320 of the surface of a lapped (polished) as-coated plasma sprayed yttrium oxide coating at magnifications of 300×, 1000×, and 5000× respectively. It is readily apparent that the flaky material has been removed from the upper surface of the coating.

FIGS. 3D, 3E, and 3F show photomicrographs 330, 340, and 350 of the surface of the lapped (polished) plasma sprayed yttrium oxide coating illustrated in FIGS. 3A through 3C after exposure to a reducing chemistry plasma. FIG. 3D is at a magnification of 300×, FIG. 3E is at a magnification of 1000×, and FIG. 3F is at a magnification of 5000×. The reducing plasma was produced in the manner described in Table One. The exposure time was 50 hours. It is readily apparent that the flaky topography has been removed from the yttrium oxide coating surface during exposure to the plasma, as illustrated by comparing FIG. 3C with FIG. 3F. However, as can be seen from FIG. 3F, the exposed coating surface (as the gradual erosion of the protective layer of yttrium oxide occurs) over processing time in a corrosive environment is still relatively susceptible to particulate formation, due to the cracks in the surface and the grain structure in general of the spray coated ceramic material. A further improvement in the spray coated yttrium oxide, to provide a dense and porosity-reduced body structure and a smooth and compact coating surface would be helpful in reducing particulate generation.

Another embodiment of the present invention pertains to improvement of the spray coating technique, to obtain a more dense spray coating which would be less susceptible to attack by reducing plasmas. After considerable experimentation, where numerous variables of the plasma spray coating process were examined, it was discovered that a substantial, unexpected reduction in porosity and surface roughness of the spray-coated yttrium oxide surface could be obtained by using a smaller particle size yttrium oxide powder feed to the plasma spray coating apparatus which was used to apply the coating to the aluminum alloy substrate.

For example, the average, conventional effective particle diameter of yttrium oxide powder fed to the plasma spray-coating apparatus prior to the present invention was larger than 25 μm in diameter. Empirical data was developed which showed that a reduction in this average powder diameter to about 22 μm or smaller, typically ranging between about 15 μm and about 0.1 μm, significantly reduced the porosity of the yttrium oxide coating produced on the aluminum alloy substrate surface.

Table Two, below shows the improvement in the physical properties of a plasma sprayed yttrium oxide coating, which properties were achieved using an embodiment of the present invention in which the size of the yttrium oxide powder feed to the plasma spray coating apparatus was changed in the manner described above.

TABLE TWO

| | | | Coating | | | HCl | | |
|---|---|---|---|---|---|---|---|---|
| | | | Surface | | Break | Bubble | | |
| Coating | Coating | | Roughness | | Down | Test* | | |
| Deposition | Thickness | | Ra | | Voltage | Hours to | Porosity** | Hardness*** |
| Technique | (mil) | (μm) | μ-inch | μm | V/mil | Failure | % | GPa |
| Prior | 8 | 200 | 200 | 5.0 | 750 | 7.5-8 | 1.5 to 4 | ≦4 |
| Technique | | | | | | | | |
| Present | 8 | 200 | 51.2 | 1.28 | 875 | >10 | <1.5 to | 4.1 |
| Invention | | | | | | | 0.15 | |
| Embodiment | | | | | | | | |

*The bubble test was performed to an Applied Materials Technical Specification, Part No. 0250-39691, which is generally known in the semiconductor industry. Currently, the failure standard for this test is the appearance of 4 hydrogen bubbles per second on a continuous basis.
**The volume porosity of the yttrium oxide coating was measured using an Image-Pro PLUS, version 6.0 (available from Media Cybernetics, Bethesda, MD) applied to a photomicrograph of the surface of the coating.
***The hardness was measured using the Vickers Hardness (Hv) test, and the HV value was calculated based on ASTM E92-82.

As illustrated in Table Two, for a 200 μm thick coating, the average porosity of the yttrium oxide coating produced using the conventional 25 μm diameter yttrium oxide powder ranged from about 1.5% to about 4%, while the average porosity of the yttrium oxide coating produced using a size-reduced equivalent diameter yttrium oxide powder size ranged from less than 1.5% down to about 0.15%. By way of example, a 15 μm equivalent diameter powder produced a coating having a porosity of about 0.47%. This decrease in porosity is particularly significant as an indicator of the ease of attack of the plasma containing reducing species. In addition, the average surface roughness Ra of the yttrium oxide coating produced using the conventional 25 μm diameter powder was about 200μ-inch Ra (5.0 μm Ra) compared with an average surface roughness of only 51.2μ-inch Ra (1.28 μm Ra) for the yttrium oxide coating produced using the size-reduced 15 μm diameter yttrium oxide powder feed to the plasma spray coating apparatus. Using the standard HCl bubble test, a 200 μm thick yttrium oxide coating produced using the conventional 25 μm equivalent diameter powder performed well for about 7.5-8 hours, while a 200 μm thick yttrium oxide coating produced using the size-reduced 15 μm diameter powder performed well for a time period in excess of 10 hours. Further, the break down voltage (V_{BD}) for the yttrium oxide coating produced using the conventional 25 μm equivalent diameter powder was only 750 V/mil, while the break down voltage for the yttrium oxide coating produced using the size-reduced 15 μm equivalent diameter powder was higher than 875 V/mil. One of skill in the art can select any of the apparatus commonly used in the industry for spray coating of yttrium-comprising coatings and obtain similar relative results with minimal experimentation.

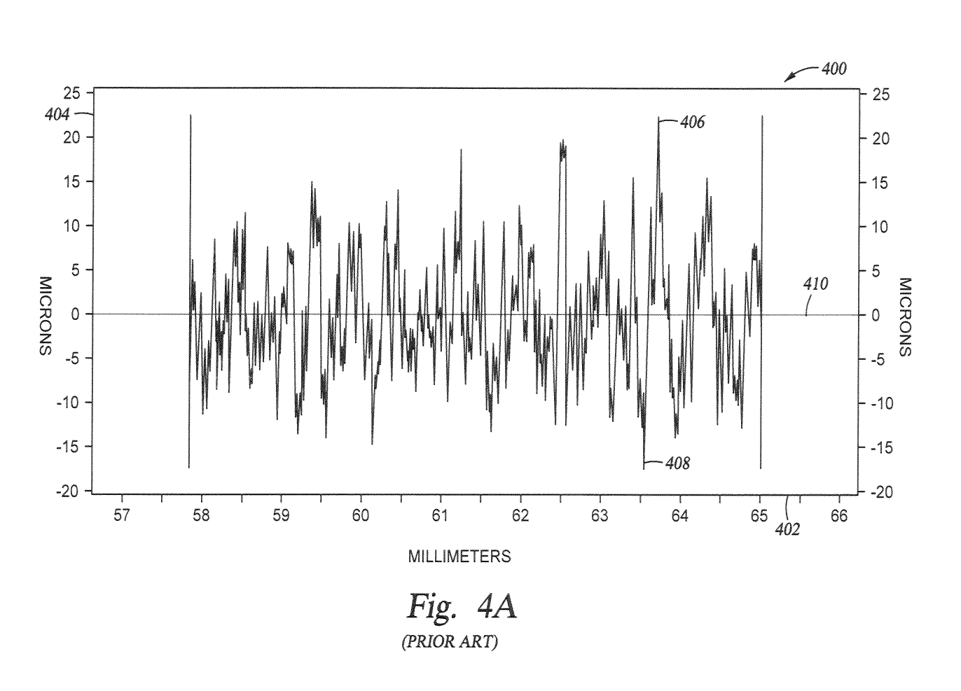

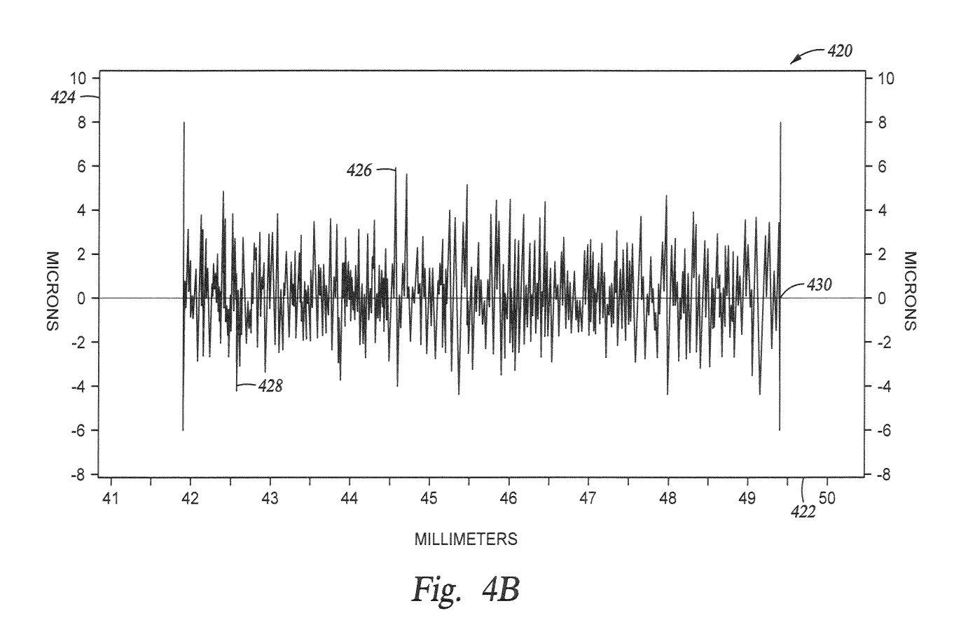

FIG. 4A is a comparative example which shows a graph 400 of the range of the surface roughness in microns from a centerline 410 along the surface of an as-coated plasma sprayed yttrium oxide coating produced using the technology available prior to the present invention. The distance of travel along the surface is shown in millimeters on axis 402, while the height above or depth beneath the centerline of the range in microns is shown on axis 404. The range in surface distance from the centerline of the range was from about +23 microns to about −17 microns.

FIG. 4B shows a graph 420 of the range of the surface roughness in microns from a centerline 430 along the surface of an as-coated plasma sprayed yttrium oxide coating. The plasma-sprayed coating was produced using the embodiment of the invention in which a reduced effective diameter powder is fed to the plasma spraying apparatus. The distance of travel along the surface is shown in millimeters on axis 422, while the height above or depth beneath the centerline of the range in microns is shown on axis 424. The range in surface distance from the centerline of the range was from about +6 microns to about −4.5 microns. This significant change in the range of the height and depth of the surface variation substantially reduces the surface area of the protective coating which is exposed to the corrosive reducing plasma.

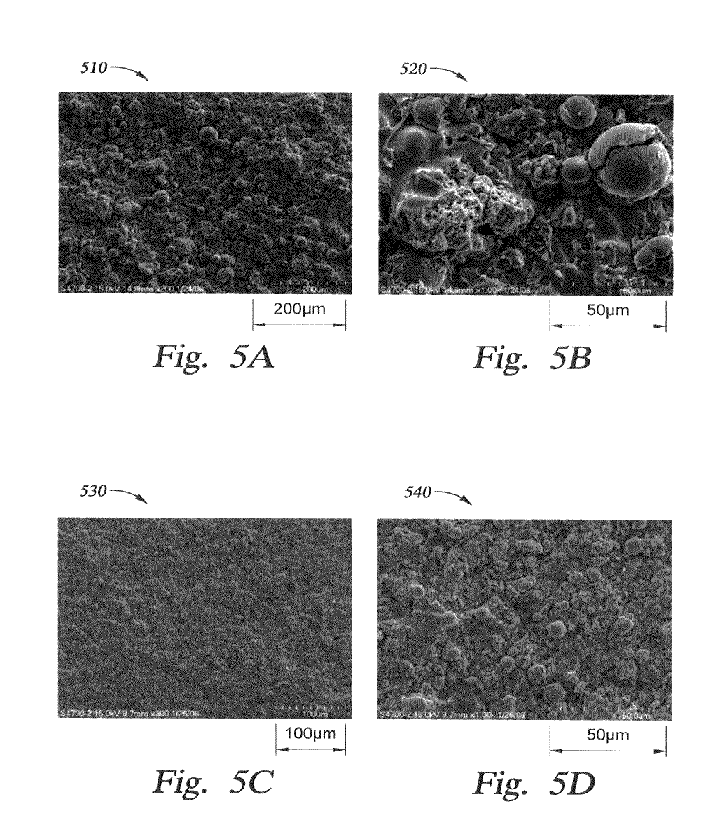

FIGS. 5A and 5B are comparative photomicrographs 510 and 520, which show a top view of the morphology of a plasma sprayed yttrium oxide coating prepared using plasma spray technology prior to the present invention, at magnifications of 200× and 1000×, respectively. FIGS. 5C and 5D are photomicrographs 530 and 540, which show a top view of the morphology of plasma sprayed yttrium oxide coating prepared using the embodiment of the present invention in which a reduced effective diameter powder is fed to the plasma spraying apparatus. FIGS. 5C and 5D are at magnifications of 200× and 1000×, respectively. A comparison of FIGS. 5A and 5B with FIGS. 5C and 5D illustrates the reduction in surface area which is subject to attack by the plasma. The surface morphology in FIGS. 5A and 5B shows increased vulnerability to attack (compared with the surface morphology in FIGS. 5C and 5D) by a reducing plasma, due to the increased exposure in a two dimensional direction by the vertical variation in the height and depth of the surface, as well as the increased surface area due to the spherical structures extending above the coating surface.

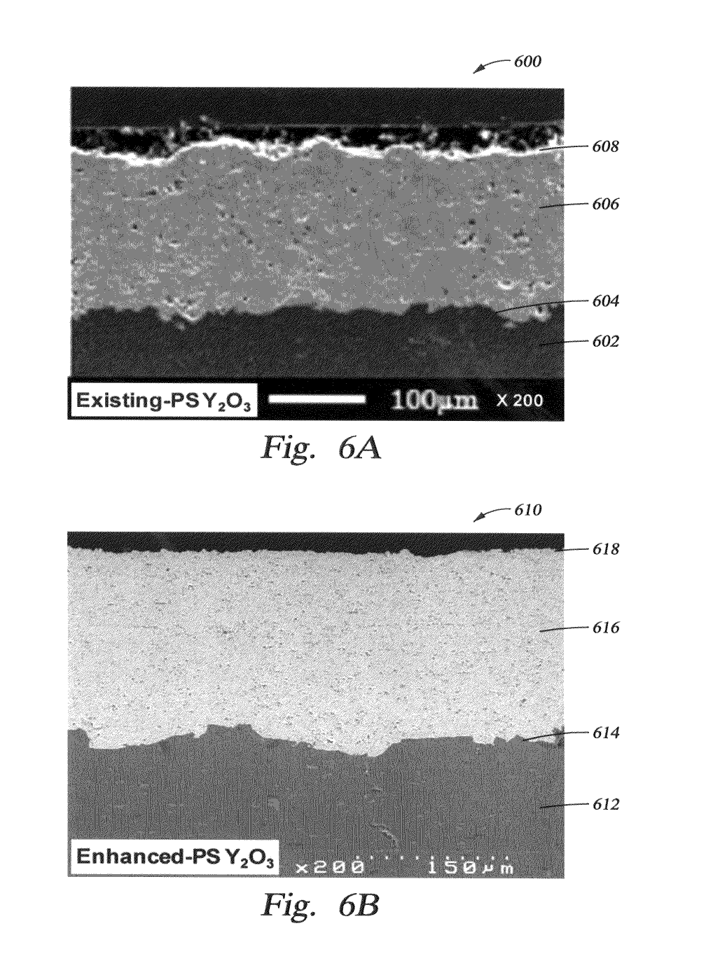

FIG. 6A is a comparative photomicrograph 600 showing a cross-sectional side view of an aluminum alloy substrate 602 having a yttrium oxide coating 606 deposited over the surface 604 of the aluminum alloy substrate 602. This comparative photomicrograph shows the characteristics of the structure which was prepared using plasma spray technology prior to the present invention, to produce a yttrium oxide coating having a thickness of about 200 μm. The magnification in the photomicrograph is 200×. The aluminum alloy substrate 602 of the test specimen is shown at the base of the photomicrograph 600. The roughness of the surface 604 of the aluminum alloy is clearly defined. The general porosity of the spray coated yttrium oxide 606 is also apparent, as is the surface 608 roughness of the coating which was prepared using the prior art plasma spray technology, where the conventional 25 μm average effective diameter yttrium oxide powder was fed to the plasma spray coater.

FIG. 6B is a photomicrograph 610 which shows the improvement in the plasma spray-coated yttrium oxide coating achieved when the reduced effective diameter powder size yttrium oxide is fed to the plasma sprayer. FIG. 6B shows a cross-sectional side view of an aluminum alloy substrate 612 having a yttrium oxide coating 616 deposited over the surface 614 of the aluminum alloy substrate. Again, the magnification is 200×. The aluminum alloy substrate 612 of the test specimen is shown at the base of the photomicrograph 610. The roughness of the surface 614 of the aluminum alloy is clearly defined, and is similar to that shown in FIG. 6A. The general porosity of the spray coated yttrium oxide 616 is considerable less than that for the coating produced using the prior art process, which is shown in FIG. 6A. The surface 618 roughness of the coating which was prepared using the embodiment of the present invention is far smoother than that produced using the prior art plasma spray technology. Photomicrographs 600 and 610 further support the data contained in the above Table Two.

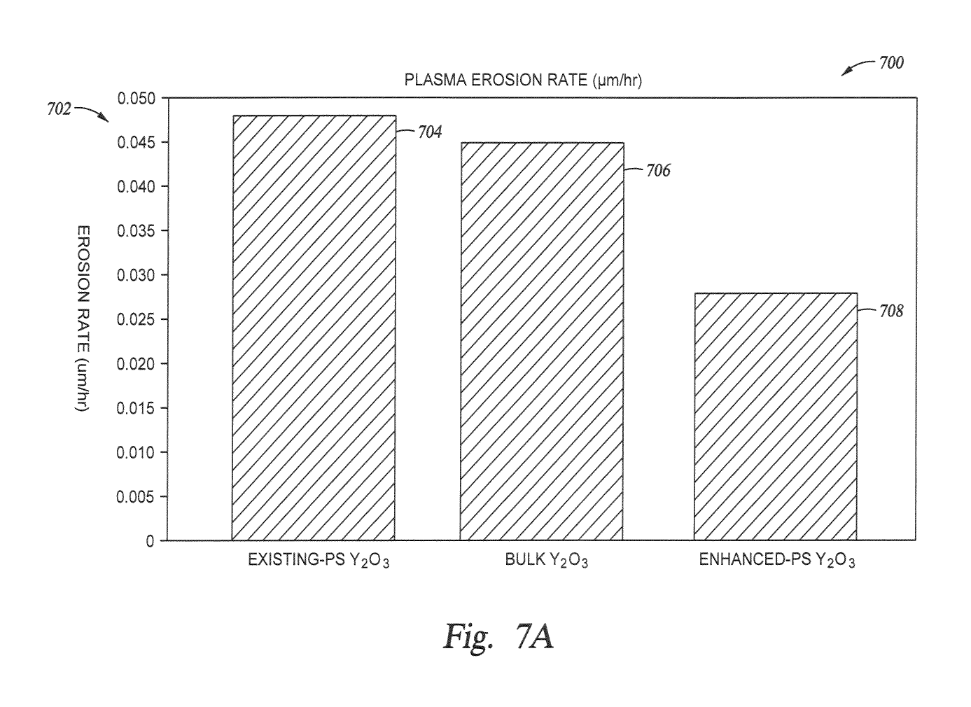

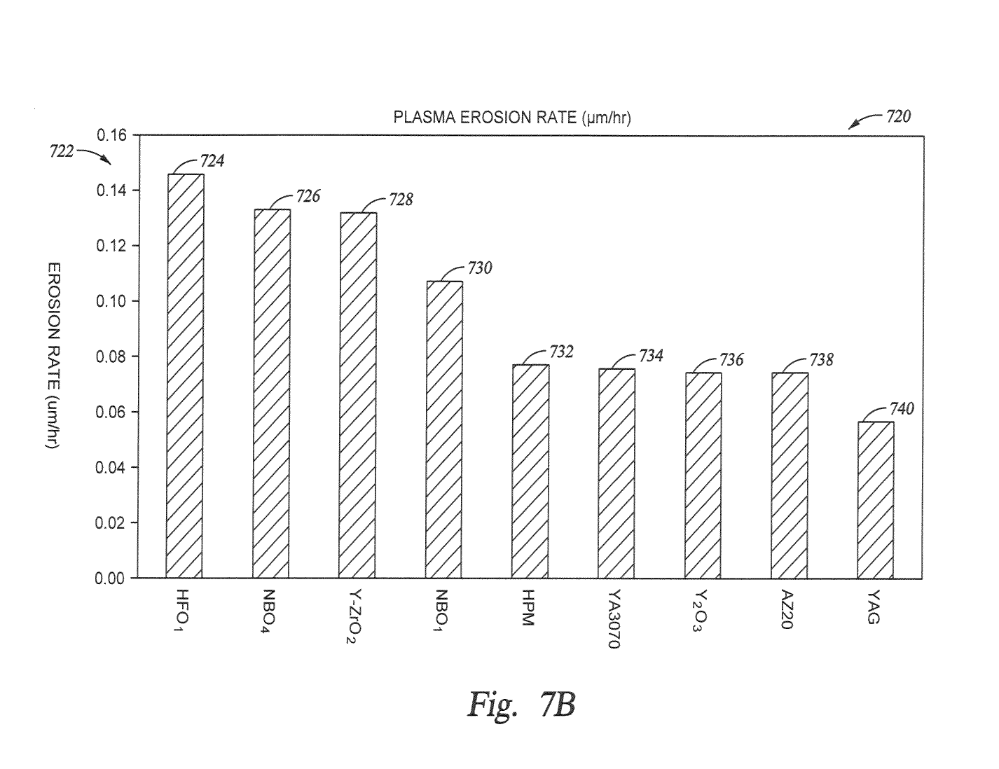

FIG. 7A shows a block diagram 700 which compares an erosion rate for a for various yttrium oxide-comprising substrates. The erosion rate for each of the yttrium oxide-comprising substrates is shown in μm/hr on axis 702 of the block diagram 700. Block 704 shows the erosion rate for a plasma sprayed yttrium oxide coating (over an aluminum alloy substrate) applied using the previous spray coating method, which employed yttrium oxide particle feed to the plasma sprayer which had an average effective particle diameter of 25 μm or larger. Block 706 shows the erosion rate for a bulk specimen substrate (of the kind previously known in the art) of yttrium oxide 706. Block 708 shows the erosion rate for a plasma sprayed yttrium oxide coating (over an aluminum substrate, where the yttrium oxide coating was applied using an embodiment of the present invention employing the reduced size powder yttrium oxide feed to the plasma spraying apparatus. Each of these test substrates was exposed to the same plasma containing reducing species. The plasma processing recipe used to produce the data shown in FIG. 7A is shown below in Table Three. The average temperature during the processing ranged between about 20° C. and 90° C., depending on the process step. The time period of exposure to the plasma was 87 hours. We determined, unexpectedly, that a spray-coated yttrium oxide processing component of the kind produced using the reduced powder yttrium oxide feed to the plasma spraying apparatus generated fewer particulates than a solid yttrium oxide component. This is thought to be due to the fact that the solid yttrium oxide component required the use of a sintering additive. Use of a sintering additive, which produces an intergranular glassy phase is a source of particulate formation.

TABLE THREE

| | | | | | | | Bias | Source | | | CSTU | He |
|---|---|---|---|---|---|---|---|---|---|---|---|---|
| | Ar | N₂ | CH₂F₂ | O₂ | CF₄ | CHF₃ | Power | Power | Press | NSTU* | in/out** | in/out** |
| Step | SCCM | SCCM | SCCM | SCCM | SCCM | SCCM | W | W | mTorr | ratio | Amp | SCCM |
| BARC | | | | | 150 | 30 | 1000 | | 300 | 1.3 | 2/0 | 10-10 |
| TRANS | | 400 | | | | | 100 | 100 | 220 | 1.35 | 14/0 | 10-10 |
| ORG | | 400 | | | | | 400 | 1200 | 220 | 1.35 | 14/0 | 10-10 |
| TRANS | | | | | 175 | 15 | 100 | 100 | 150 | 3 | 10/−2 | 10-10 |
| ME | | | | | 175 | 15 | 500 | 1500 | 150 | 3 | 10/−2 | 10-10 |
| TRANS | 500 | | | 250 | | | 100 | 100 | 10 | 1.35 | 10/0 | 20-20 |
| PET | | | | 500 | | | 200 | 1000 | 10 | 1.35 | 10/0 | 20-20 |

*NSTU: Neutral Species Tuning Unit (ratio).
**CSTU: Changed Species Tuning Unit (Ampere).
***Helium coolant feed to the substrate support platform, to the inside fluid circulation ring and to the outside fluid circulation ring at the support platform surface.

FIG. 7B shows a block diagram 720 which compares an erosion rate for a series of bulk materials, each having a different chemical composition. Each of these test specimens was exposed to the same plasma containing reducing species per the recipe provided in Table One, in the 300 mm eMax CT+ processing chamber. The performance of YAG bulk material confirmed the theories about the avoidance of the formation of Y(OH)₃ in a reducing plasma as a method of improving erosion resistance. Block 724 represents an HF01 substrate; Block 726 represents an NB04 substrate; Block 728 represents a Y—ZrO2 substrate; Block 730 represents an NB01 substrate; Block 732 represents an HPM substrate; Block 734 represents a YA3070 substrate; Block 736 represents a Y₂O₃ substrate; Block 738 represents a YZ20 substrate; and Block 740 represents a YAG substrate. Blocks 736, 738, and 740 are of the highest interest, because they represent bulk substrates for Y₂O₃, a Y₂O₃—ZrO₂ solid solution containing 20 atomic % ZrO₂, and YAG, respectively. These three materials have been shown to be particularly resistant to a reducing plasma when applied by plasma spray coating in accordance with one of the embodiments of the present invention.

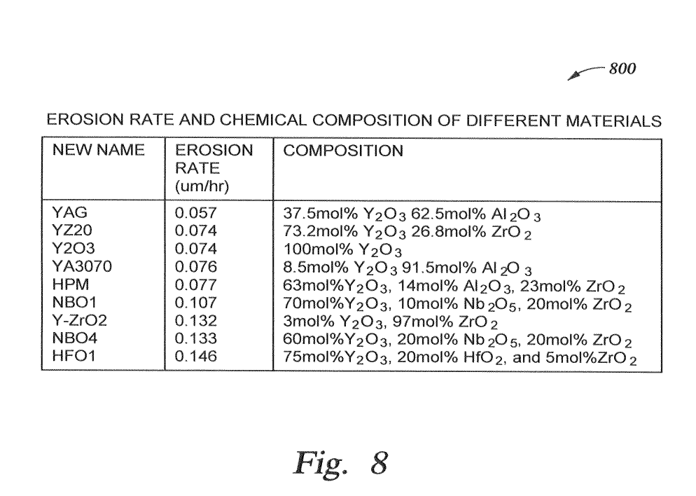

FIG. 8 shows a Table 800, which lists the chemical compositions of various starting powders of various bulk materials, the erosion rates of which are illustrated in FIG. 7B.

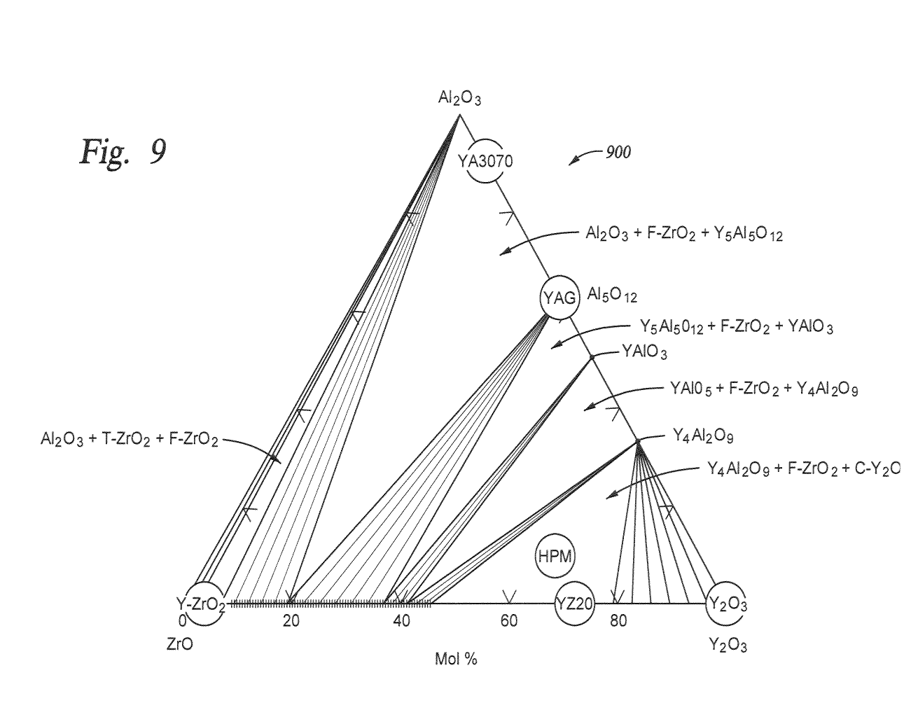

FIG. 9 shows a phase diagram 900 which illustrates the chemical compositions of starting powders and phases in the final materials formed, where the materials are listed in Table 800.

While working to improve the performance of the yttrium oxide coating, the discovery was made that the mechanism of attack of the yttrium oxide surface is through the formation of yttrium hydroxide, Y(OH)₃. When reactive plasma species of hydrogen and oxygen are present, the Y(OH)₃ compound is formed. When reactive plasma species of hydrogen, fluorine, and oxygen are present, the Y(OH)₃ compound is formed. In theory, by looking at the thermodynamics data (Gibbs formation free energy) for various compounds, it is possible to determine the probability that the Y(OH)₃ compound will be formed. In experimentation, high resolution XPS has been used to detect the formation of Y(OH)₃. Experimentation has shown that the use of (Yttrium Aluminum Garnet), which is commonly in a Y₃Al₅O₁₂ form, and also the use of Y₂O₃—ZrO₂ solid solution avoids the formation of Y(OH)₃. In addition, further study has indicated that YF₃ is thermodynamically stable and resistant to the formation of Y(OH)₃, making this material desirable for use as a protective coating in an plasma environment which contains reducing active species. Thus YAG, Y₂O₃—ZrO₂ solid solution, or YF₃, or combinations thereof, are excellent materials for use as a protective coating in a plasma environment which contains reducing active species. To provide an advantageous porosity in the range of about 0.5% or less, and a break down voltage (V_{BD}) of 875 or greater, the average (equivalent diameter) particle size of the powder used to deposit a plasma sprayed YAG, Y₂O₃—ZrO₂ solid solution, or YF₃ coating ranges from about 22 μm to about 5 μm. Again, equivalent diameter particle sizes down to about 0.1 μm may be used if the spray-coating apparatus can be adapted to handle particles of this size Use of this size-reduced powder should reduce porosity of a plasma-sprayed coating and provide a more dense structure in the same manner as observed with the use of the size-reduced powder in plasma-sprayed Y₂O₃-comprising coatings.

While the foregoing is directed to embodiments of the present invention, other and further embodiments of the invention may be devised in view of the present disclosure, without departing from the basic scope of the invention, and the scope thereof is determined by the claims which follow.

We claim:

1. An article which is resistant to corrosion or erosion by chemically active reducing plasmas, said article comprising a metal or metal alloy substrate having on its surface a spray coated yttrium-comprising ceramic material, wherein a porosity of said ceramic coating is less than 1.5%.

2. An article in accordance with claim 1, wherein said porosity ranges from less than 1.5% to about 0.1%.

3. An article in accordance with claim 2, wherein said porosity ranges from about 1% to about 0.1%.

4. An article in accordance with claim 1, wherein an exposed surface of said spray coated yttrium-comprising ceramic material has a surface roughness of less than about 3 μm Ra.

5. An article in accordance with claim 3, wherein said surface roughness ranges from less than about 1.5 μm Ra to about 0.6 μm Ra.

6. An article in accordance with claim 1, wherein the break down voltage of said spray-coated yttrium-comprising ceramic material is at least above 650 V/mil.

7. An article in accordance with claim 6, wherein said break down voltage ranges from about 650 V/mil to greater than 900 V/mil.

8. An article in accordance with claim 1 or claim 4, or claim 6, wherein said spray coated yttrium-comprising ceramic material has a thickness ranging from about 5 μm to about 400 μm.

9. An article in accordance with claim 8, wherein said material thickness ranges from about 25 μm to about 300 μm.

10. An article in accordance with claim 8, wherein said yttrium-comprising ceramic material is selected from the group consisting of Y₂O₃, Y₂O₃—ZrO₂ solid solution, YAG, YF₃ and combinations thereof.

11. An article in accordance with claim 2, wherein said spray-coated yttrium-comprising ceramic material passes an HCl Bubble Test for a time period of at least 8 hours.

12. An article in accordance with claim 3, wherein said spray-coated yttrium-comprising ceramic material passes an HCl Bubble Test for a time period of at least 10 hours.

13. A method of fabricating an article which is resistant to corrosion or erosion by chemically active reducing plasmas, comprising: fabricating said article by plasma spray-coating a metal or metal alloy substrate with a yttrium-comprising ceramic material, wherein said yttrium-comprising ceramic material is in the form of a powder having an average equivalent diameter ranging from about 22 μm to about 0.1 μm.

14. A method of fabricating an article in accordance with claim 13, wherein said powder has an average equivalent diameter ranging from about 15 μm to about 5 μm.

15. A method of fabricating an article in accordance with claim 13 or claim 14, wherein said yttrium comprising material is selected from the group consisting of Y₂O₃, Y₂O₃—ZrO₂ solid solution, YAG, YF₃ and combinations thereof.

16. A method in accordance with claim 13, wherein said yttrium comprising material is selected from the group consisting of Y₂O₃—ZrO₂ solid solution, YAG, YF₃ and combinations thereof.

17. A method of fabricating an article which is resistant to corrosion or erosion by chemically active reducing plasmas, comprising: fabricating said article by plasma spray-coating a metal or metal alloy substrate with a yttrium-comprising ceramic material, wherein said yttrium-comprising ceramic material is selected from the group consisting of Y₂O₃—ZrO₂ solid solution, YF₃ and combinations thereof.
